(19) United States
(12) Patent Application Publication
(10) Pub. No.: US 2023/0381779 A1
(43) Pub. Date: Nov. 30, 2023

(54) CELL LYSIS WITH MAGNETIC PARTICLES AND A RESISTOR

(71) Applicant: HEWLETT-PACKARD DEVELOPMENT COMPANY, L.P., Spring, TX (US)

(72) Inventors: Alexander Govyadinov, Corvallis, OR (US); Viktor Shkolnikov, Palo Alto, CA (US)

(73) Assignee: Hewlett-Packard Development Company, L.P., Spring, TX (US)

(21) Appl. No.: 18/032,710

(22) PCT Filed: Oct. 20, 2020
(86) PCT No.: PCT/US2020/056451

§ 371 Date: Apr. 19, 2023

(51) Int. Cl. B01L 3/00; G01N 35/00; B01L 3/02

(52) U.S. Cl. CPC B01L 3/502761; G01N 35/0098; B01L 3/0268; B01L 2300/1827; B01L 2400/043; B01L 2400/0442; G01N 2035/00237

(57) ABSTRACT

A method comprising receiving, at a microfluidic channel, a biologic sample including a cell and providing a magnetic field within the microfluidic channel using a first magnet, wherein the magnetic field attracts a first plurality of magnetic particles disposed within the microfluidic channel. The method further includes activating a first resistor disposed within the microfluidic channel to agitate a volume of fluid within the microfluidic channel, and in response, moving the first plurality of magnetic particles through the microfluidic channel to lyse the cell and to release cellular material from the cell.

### BACKGROUND

Cell lysis is a process of rupturing cellular membranes and extracting intracellular material, including deoxyribonucleic acid (DNA), ribonucleic acid (RNA), proteins, and organelles, among other material. Cell lysis may be used for a variety of different applications.

### BRIEF DESCRIPTION OF THE DRAWINGS

FIG. 1 illustrates an example method of lysing a cell with a first plurality of magnetic particles and a first resistor within a microfluidic channel, in accordance with the present disclosure.

FIGS. 2A-2D illustrate an example apparatus including a microfluidic channel with a first magnet collocated with a first resistor, in accordance with the present disclosure.

FIG. 3 illustrates another example apparatus including a microfluidic channel with a first magnet and a first resistor, in accordance with the present disclosure.

FIGS. 4A-4D illustrate a variety of different example apparatuses for performing cell lysis with a first plurality of magnetic particles and a first resistor, in accordance with the present disclosure.

FIGS. 5A-5B illustrate an example apparatus for performing cell lysis and sorting with a first plurality of magnetic particles and a first resistor, in accordance with the present disclosure.

FIGS. 6A-6D illustrate a variety of different example apparatuses for performing cell lysis with a first plurality of magnetic particles and a first resistor, in accordance with the present disclosure.

FIGS. 7A-7B illustrate a variety of different example apparatuses for performing cell lysis with a first plurality of magnetic particles and a first resistor, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Biological cells are the basic building blocks of skin, tissues, and other materials. Cells and their organelles are enveloped by thin membranes that separate their chemical contents from the extracellular environment. As noted above, cell lysis refers to a process of rupturing cellular membranes and extracting intracellular material, such as DNA, RNA, and proteins, among other material. Lysing cells may be used for analyzing cellular material for a variety of applications. For example, cell lysing may be a step in preparing a sample for polymerase chain reaction (PCR). Cells may be lysed using mechanical, chemical, enzymatic and/or thermal lysis. With chemical and/or enzymatic lysing, additional chemical compounds are introduced, which may interfere with downstream analysis. Thermal lysis may degrade analytes, which may reduce downstream detection. Further, some cells may be easier than others to lyse. As a non-limiting example, gram-negative bacterial may be lysed more easily using thermal or chemical lysis, whereas gram-positive bacteria, eukaryotes, and tissue examples may be harder to lyse using thermal or chemical means.

Examples in accordance with the present disclosure are directed to apparatuses that perform mechanical cell lysis using magnetic particles that are actuated using a magnetic field and a resistor. The apparatuses may receive a fluid including a biologic sample, and process the biologic sample for further analysis, such as for detecting pathogens, diagnosing a patient, immunology analysis and/or molecular diagnosis. Example apparatuses perform mechanical lysis within a microfluidic device via controlled magnetic particle motion. The mechanical lysis may not produce contaminates and may minimize degrading of analytes as compared to other lysing techniques.

Accordingly, disclosed herein is a compact, integrated microfluidic apparatus compatible with integration into point-of-care instruments to perform mechanical cell lysis and, optionally, cellular material sorting. The biologic sample is introduced to the apparatus, which may include fluidic pumps to actively move fluid through microfluidic channels of the apparatus. A plurality of magnetic particles may be locally corralled via a magnetic field provided in a particular microfluidic channel for lysing. In response to the introduction of the biologic sample into the particular microfluidic channel, a resistor may generate a vapor bubble to dispense the magnetic particles into a cell of the biologic sample. The magnetic particles may have Stokes numbers that are greater than unity, which may cause the magnetic particles to have a different velocity than the surrounding fluid velocity. The different velocity of the magnetic particles may cause local shear near the magnetic particles, which may be applied to the cell for lysing. In some examples, the magnetic particles may have a coating that binds to analytes of interest, which may be used to concentrate the analytes and/or preserve the analytes from degrading. The lysed cell material may be passed downstream and/or ejected from the apparatus for analysis.

In a particular example, a method for performing cell lysing includes receiving, at a microfluidic channel, a biologic sample including a cell. The method includes providing a magnetic field within the microfluidic channel using a first magnet, wherein the magnetic field attracts a first plurality of magnetic particles disposed within the microfluidic channel. The method further includes activating a first resistor disposed within the microfluidic channel to agitate a volume of fluid within the microfluidic channel, and in response to agitating the volume of fluid, moving the first plurality of magnetic particles through the microfluidic channel to lyse the cell and to release cellular material from the cell.

As another example, an apparatus may comprise a microfluidic channel that includes a first plurality of magnetic particles, a first magnet, and a first resistor. The microfluidic channel is to pass a volume of a biologic sample. The first magnet is disposed with the microfluidic channel to provide a magnetic field that attracts the first plurality of magnetic particles. The first resistor is disposed within the microfluidic channel and collocated with the first magnet. The first resistor may be activated to disperse the first plurality of magnetic particles from the magnetic field and to move the first plurality of magnetic particles through the microfluidic channel to lyse a cell in the biologic sample.

As a further example, an apparatus comprises a microfluidic channel including a first plurality of magnetic particles, a first magnet, a first resistor, and circuitry. The microfluidic channel is to pass a volume of a biologic sample. The first magnet is disposed with the microfluidic channel to provide a magnetic field that attracts the first plurality of magnetic particles. The first resistor is disposed within the microfluidic channel. The circuitry is coupled to the first resistor to activate the first resistor to disperse the first plurality of magnetic particles from the magnetic field and move the first plurality of magnetic particles through the microfluidic channel to lyse a cell in the biologic sample and to release cellular material from the cell.

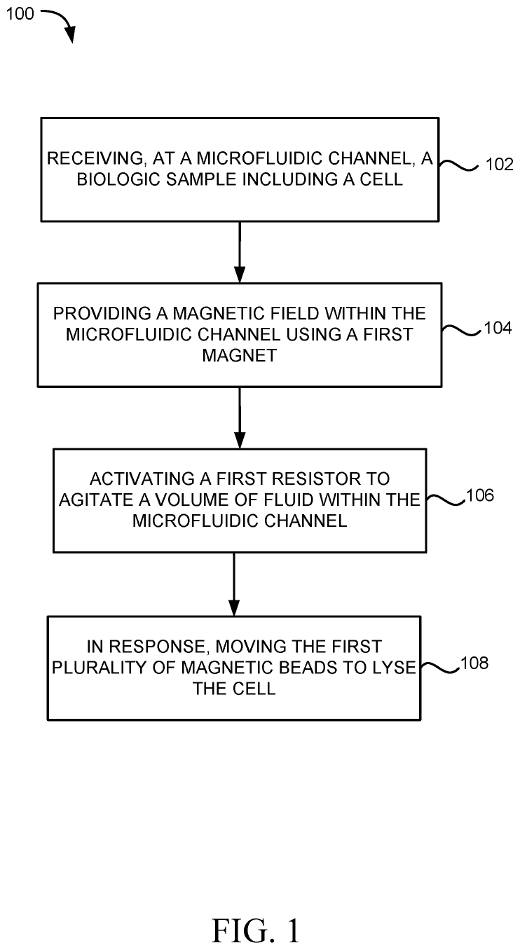

Turning now to the figures, FIG. 1 illustrates an example method of lysing a cell with a first plurality of magnetic particles and a first resistor within a microfluidic channel, in accordance with the present disclosure. The method 100 may be performed by an apparatus which includes a microfluidic channel, a first magnet, and a first resistor disposed within the microfluidic channel, as further illustrated herein.

At 102, the method 100 includes receiving, at a microfluidic channel, a biologic sample that includes a cell. The microfluidic channel may form part of a microfluidic device used to process and/or analyze the biologic sample. The biologic sample may be mixed with a medium and/or a buffer, and loaded into the microfluidic device, such as into an inlet or a cell fluid reservoir that is coupled to the microfluidic channel.

At 104, the method 100 includes providing a magnetic field within the microfluidic channel using a first magnet. The first magnet may be disposed with the microfluidic channel. In some examples, the magnetic field may be provided in response to receiving the biologic sample at the microfluidic channel; however, examples are not so limited. The magnetic field may attract a first plurality of magnetic particles that are disposed within the microfluidic channel. The first plurality of magnetic particles may be in the microfluidic channel prior to the biologic sample, such as by loading the first plurality of magnetic particles into the microfluidic device prior to loading the biological sample. In some examples, the first plurality of magnetic particles may be provided within the microfluidic channel during production of the apparatus. The first magnet may include a permanent magnet or an electromagnet, in various examples.

Magnetic particles, as used herein, include and/or refer to particles that have magnetic properties and/or are otherwise capable of being attracted to or repelled by a magnetic field. The magnetic particles may be of a size such that the particles are capable of moving through the microfluidic channel. For example, the magnetic particles may be between 1 micrometer (μm) and 20 millimeter (mm) in diameter as non-limiting examples. The magnetic particles may be formed of, for example, glass, polymer, silica, alumina, silicon carbide, tungsten carbide iron oxide steel, silica coated metal, boron nitride, or other suitable material which is magnetic, is made with magnetic atoms, and/or includes a core with a magnetic coating. For instance, example magnetic particles may consist essentially of iron oxide, a soft ferrite, a ferromagnetic material, a ferrimagnetic material, or combinations thereof. Non-limiting example compositions of magnetic particles include iron oxide (Fe₂O₃), soft ferrites ranging from spinel-type ferrites (MeFe₂O₄) to manganese-zinc ferrite (MnₐZn₍₁₋ₐ₎Fe₂O₄), nickel-zinc ferrite (NiₐZn₍₁₋ₐ₎Fe₂O₄), and a nickel-iron alloy (Ni—Fe (80:20)), among others. The magnetic particles may be spherical, such as beads, or may not be spherical, such as disk-shaped, rock or gravel-like, or other suitable shapes. The magnetic particles may be monodispersed or poly-dispersed. In some examples, the magnetic particles may include a core formed of a non-magnetic material and a magnetic coating, such as a tungsten carbide core and an iron oxide coating as a non-limiting example. The core may increase the density of the magnetic particles and the magnetic coating provides the magnetic properties.

In some examples, the magnetic particles may be of a size of between mm diameter for small cells, such as bacteria. For larger cells, such as yeast, algae, and hyphae, magnetic particles of between 0.5-1.25 mm diameter may be used. For homogenizing plant or animal tissue, magnetic particles of between 1.0-5.0 mm diameter may be used. In some examples, the magnetic particle size may be comparable or larger than the cell size. For example, bacteria cells may be 2-10 μm and eukaryotic cells may be 10-100 μm in size. In some example, the magnetic particles may have diameters of between 2 to mm.

At 106, the method 100 includes activating a first resistor disposed within the microfluidic channel to agitate a volume of fluid within the microfluidic channel. In response to agitating the volume of fluid, at 108, the method 100 includes moving the first plurality of magnetic particles through the microfluidic channel to lyse the cell and to release cellular material from the cell.

The first plurality of magnetic particles may have a density sufficient to provide energy for lysing. In some examples, the magnetic particles may include or be formed of material such as zirconium oxide with a specific gravity from 3.8-6.0, stainless steel with a specific gravity of 7.0 or more, tungsten carbide with a specific gravity of 12 or more, and uranium with a specific gravity of 19 or more. In some example, the magnetic particles may have a material on edges of the particles, such as silicon carbide grit.

In some examples, moving the first plurality of magnetic particles may include moving the first plurality of magnetic particles at a different velocity than a velocity of surrounding fluid, thereby generating local shear near the cell. The first plurality of magnetic particles may have Stokes numbers that are greater than unity. For example, in response to activation of the first resistor, the Stokes numbers may cause the first plurality of magnetic particles to have a velocity that is different than the surrounding fluid velocity. The different velocity may cause the first plurality of magnetic particles to not follow the motion of the surrounding fluid, which may be referred to as the “main flow”. For example, the magnetic particles may be able to move and produce their own flow in the local vicinity. The Stokes number may be defined as

$$\frac{{u}_{o} {P}_{{pd}_{p}}}{18 {u}_{f}} ,$$

where u₀ is the characteristic velocity of the main flow, Pₚ is the density of the magnetic particles, dₚ is the diameter of the magnetic particles, and u_{f} is the fluid dynamic velocity. For resistor actuation, the characteristic velocity is the peak fluid velocity during firing, which may be 10-20 meters/second. To achieve the shearing, such as achieving a Stokes number of 10, magnetic particles with densities on an order of 10 grams/milliliter (g/mL) may have diameters as small as 1 um. Example magnetic particles with densities on an order of 10 g/mL may be formed of tungsten carbide. To use magnetic particles with smaller densities, such as glass having densities on an order of 2 g/mL, the magnetic particles may be 5 um or larger.

In some examples, the first resistor is a thermal resistor, such as a thermal inkjet (TIJ) resistor. Although examples are not so limited and a variety of different types of resistors may be used. The first resistor may be activated to create a vapor bubble within the microfluidic channel that disperses the first plurality of magnetic particles. For example, the method 100 may include applying energy to the first resistor that super heats the first resistor and a volume of surrounding fluid. The method 100 may further include removing the energy from the first resistor, which causes the vapor bubble to collapse. During vapor bubble collapse, a fluidic bubble jet may be produced that concentrates the residual kinetic energy of the bubble to provide a high pressure. The high pressure from expanding and collapsing bubbles, which may be up to about 80 bars of pressure during expansion of the bubble (and thousands of bars during the collapse of the bubble), may be used to disperse the first plurality of magnetic particles around the microfluidic channel. In some examples, the vapor bubble may cause movement of the first plurality of magnetic particles and the cell of the biologic sample. For example, the first resistor may be activated at a frequency that ensures movement of the cell and the first plurality of magnetic particles by exposing the cell and the first plurality of magnetic particles to multiple high pressure spikes from multiple bubble and expansion collapse events.

When a cell gets between respective magnetic particles or between a wall of the microfluidic channel and a magnetic particle, the cell may be squeezed and ruptures, which functions to lyse the cell. Cellular material that is lysed from the cell may be moved through the remainder of the microfluidic channel and/or ejected. As described above, the magnetic particles may have a different density than the volume of fluid which surrounds the first resistor, and the agitating of the volume of fluid may cause the volume of fluid to move at a different velocity than the velocity of the first plurality of magnetic particles. The different velocity may generate additional local shear that may be used to lyse the cell. The greater the difference in density between the magnetic particles and the fluid, the greater the difference in velocity and the greater the local shear. The cell flowing along the microfluidic channel may experience the shear and may be lysed. The lysed cellular material may be transported downstream or ejected for further analysis.

Although the above describes lysing of a cell, examples are not so limited. In various examples, a plurality of cells may be lysed at the same time and/or using multiple lysing processes along the microfluidic channel.

In some examples, the method 100 may further include releasing the first plurality of magnetic particles from the first magnetic field concurrently with and/or prior to the activation of the first resistor. For example, the method 100 may include heating the first plurality of magnetic particles prior to agitating the volume of fluid to control magnetic properties of the first plurality of magnetic particles. In such examples, the first magnet may include a permanent magnet, however examples are not so limited. In some examples, the heating may be used to weaken the cellular membrane as to enable easier lysing. For example, the apparatus may include a heating source which may assist with lysing by elevating the cellular membrane temperature to help disrupt the membrane.

In some examples, the magnetic properties may be controlled by heating the particles above a Curie temperature of the first plurality of magnetic particles. For example, the Curie temperature may be in a range of 45-95 degrees Celsius. As used herein, a Curie temperature refers to a temperature above which certain materials lose their permanent magnetic properties, which may be replaced by induced magnetism. The Curie temperature is a property of the material comprising the magnetic particles, and relative proportions of materials (as appropriate). Upon reaching the Curie temperature, the material crystal lattice undergoes a dimensional change, causing a reversible loss of magnetic dipoles. Once the magnetic dipoles are lost, the magnetic properties cease.

The first plurality of magnetic particles may be heated using a variety of different heat sources. In some examples, the first resistor and/or the first magnet may be used to heat the first plurality of magnetic particles and/or surrounding fluid. For example, the first magnet may be used to provide an oscillating magnetic field. When exposed to an oscillating magnetic field, the first plurality of magnetic particles heat up, through hysteresis losses, until they reach their Curie temperature. In other examples, the first resistor is actuated to cause the heating.

Although examples are not so limited, and the first plurality of magnetic particles may be heated using a second resistor and/or other heat sources. The heat source may be collocated with the first magnet. For example, a second resistor may be disposed within the microfluidic channel, and activated to heat the first plurality of magnetic particles above the Curie temperature, and in response, releases the magnetic particles from the magnetic field. In response to the release, the first resistor may be activated, as described above.

In some examples, the first plurality of magnetic particles may be released from the first magnetic field via control of the magnetic field. For example, the first magnet may include an electromagnet that provides the magnetic field via electrical control. In such examples, the method 100 may include applying energy to the first magnet to provide the magnetic field and removing the energy to remove the magnetic field and release the first plurality of magnetic particles prior to or concurrently with activating the first resistor.

The method 100 may include a variety of variations, such as the use of different types of magnetic particles, different arrangements of the first magnet and first resistor, and/or different numbers of magnets and resistors for dispersing the magnetic particles.

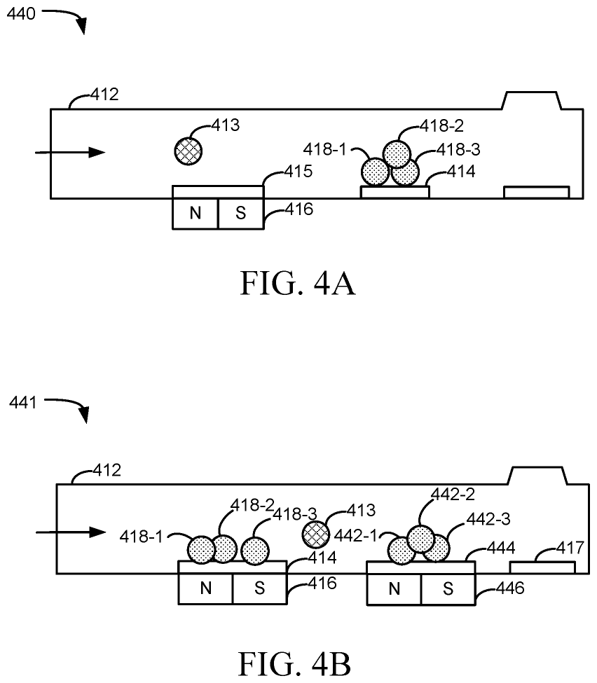

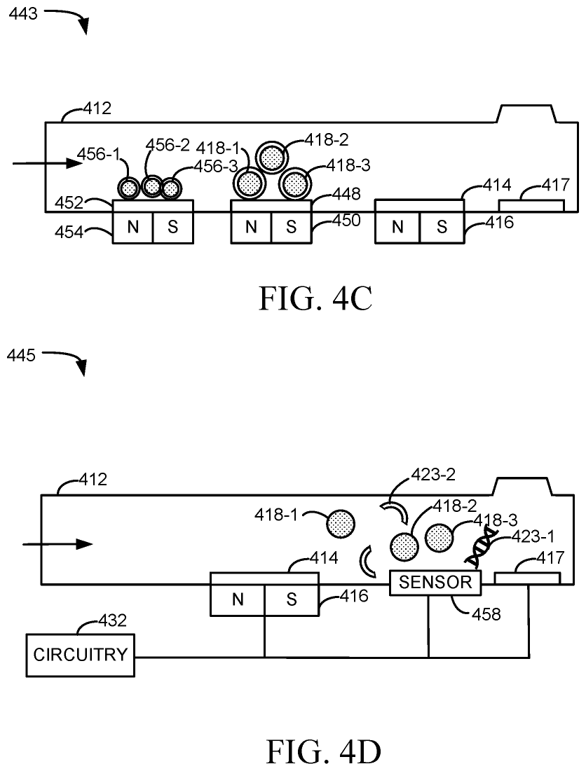

As a particular example, the method 100 may include a converging lysis process, as further illustrated by FIG. 4B. For example, the method 100 may include providing a second magnetic field within the microfluidic channel using a second magnet. The second magnetic field may attract a second plurality of magnetic particles disposed within the microfluidic channel. The method 100 may further include activating a second resistor disposed within the microfluidic channel to agitate a second volume of fluid within the microfluidic channel, and in response, moving the second plurality of magnetic particles through the microfluidic channel. In some examples, the first and second plurality of magnetic particles may lyse the cell, and the first magnet and first resistor may be downstream from the second magnet and second resistor within the microfluidic channel.

Other example variations to the method 100 may include use of different types of magnetic particles to bind to different analytes. For example, the first plurality of magnetic particles may bind to a first type of analyte among the cellular material. The microfluidic channel may further include a second plurality of magnetic particles that bind to a second type of analyte among the cellular material. The first plurality of magnetic particles and the second plurality of magnetic particles may be different sizes and/or densities, such that the first and second types of analytes may be sorted using additional magnetic fields, filters, and/or other sorting techniques, as further illustrated herein. Examples are not limited to two different types of magnetic particles and may include additional numbers of different types of magnetic particles.

As used herein, a different type of magnetic particle refers to a magnetic particle with a Curie temperature, a size, a density, and/or a coating that differs from another type of magnetic particle. In some examples, different types of magnetic particles may have a same Curie temperature but are a different size and/or density, and/or have a different coating that binds to a different type of analyte. In some examples, different types of magnetic particles may be of the same size and/or density, but have a different Curie temperature. For example, magnetic particles may be coated with silica or carboxylic acids to bind to nucleic acids, coated with poly(T) tail to bind to specific RNA or poly(A), or coated with specific nucleic acid sequences or antibodies to bind to specific DNA, RNA, and/or proteins.

In further examples, the method 100 may include multiple lysing processes. For example, the microfluidic channel may include a first channel with a plurality of branches, each having a first plurality of magnetic particles, and/or a recirculation loop with the first plurality of magnetic particles. The method 100 may further include determining whether the cell is lysed using a sensor disposed with the microfluidic channel. In response to determining the cell is unlysed, an additional lysing process may be performed. In response to determining the cell is lysed, the cell may be moved downstream and/or ejected for further analysis.

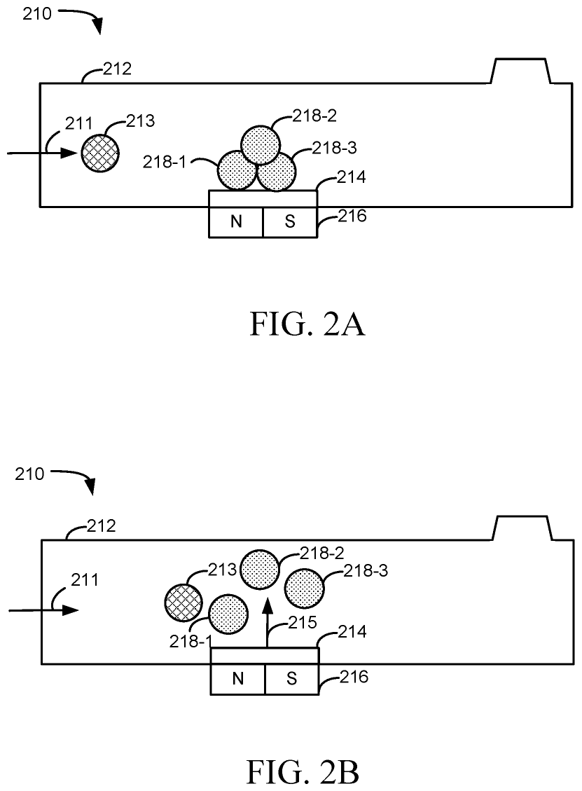

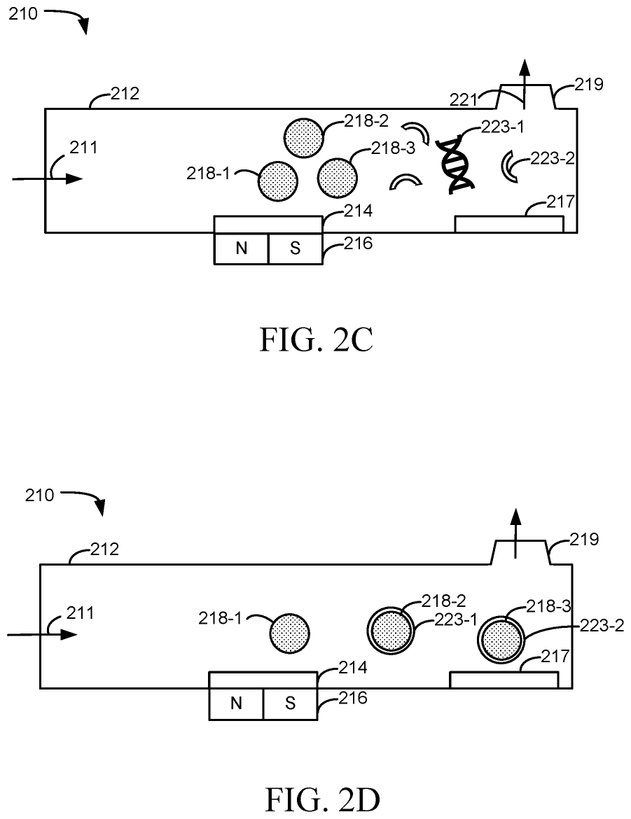

FIGS. 2A-2D illustrate an example apparatus including a microfluidic channel with a first magnet collocated with a first resistor, in accordance with the present disclosure. As shown by FIG. 2A, the apparatus 210 includes a microfluidic channel 212 that includes a first plurality of magnetic particles 218-1, 218-2, 218-3, herein generally referred to as “the first plurality of magnetic particles 218” for ease of reference. The microfluidic channel 212 may pass a volume of a biologic sample, which may include a cell 213. Although not illustrated, the biologic sample may be passed via a fluidic pump that actively moves fluid through the microfluidic channel 212, as shown by arrow 211 illustrating fluid flow.

The apparatus 210 includes a first magnet 216 and a first resistor 214. The first magnet 216 may be disposed with the microfluidic channel 212. The first magnet 216 may provide a magnetic field that attracts the first plurality of magnetic particles 218. The magnetic field may corral the first plurality of magnetic particles 218 in a specific location of the microfluidic channel 212, such that the first plurality of magnetic particles 218 are proximal to the first resistor 214 and/or may be prevented from being displaced. The first resistor 214 may be disposed within the microfluidic channel 212 and collocated with the first magnet 216. The first resistor 214 may agitate a volume of fluid within the microfluidic channel 212 to disperse the first plurality of magnetic particles 218.

As used herein, the first resistor 214 being collocated with the first magnet 216 refers to an overlapping position of the first resistor 214 and the first magnetic 216 with respect to the microfluidic channel 212, such that the magnetic field provided by the first magnet 216 and the agitated volume of fluid provided by the first resistor 214 are aligned and/or overlap within the microfluidic channel 212. For example, the first resistor 214 being collocated with the first magnet 216 may include the first resistor 214 being stacked with and/or layered with the first magnet 216. As the first resistor 214 is collocated with the first magnet 216, the magnetic field may corral the first plurality of magnetic particles 218 sufficiently proximal to the first resistor 214 that the first resistor 214 may agitate the volume of fluid and the agitated volume of fluid causes the first plurality of magnetic particles to disperse, such as for lysing the cell 213.

In various examples, the apparatus 210 may include a microfluidic device and coupled circuitry that controls components of the microfluidic device. The microfluidic device may include the microfluidic channel 212, the first magnet 216, and the first resistor 214, as further described below.

FIGS. 2B-2D illustrate example operations of the apparatus 210 illustrated by FIG. 2A. For example, as shown by FIG. 2B, the first resistor 214 may be activated to disperse the first plurality of magnetic particles 218 from the magnetic field provided by the first magnet 216. The first resistor 214 may agitate a volume of fluid, as shown by the arrow 215, to move the first plurality of magnetic particles 218.

In some examples, the apparatus 210 further includes circuitry coupled to the first resistor 214. The circuitry may be used to disperse the first plurality of magnetic particles 218 and move the first plurality of magnetic particles 218 through the microfluidic channel 212 to lyse a cell 213 in the biologic sample and to release cellular material from the cell 213, such as by activating the first resistor 214 as previously described.

In some examples, the first plurality of magnetic particles 218 may be released from the magnetic field prior to moving the first plurality of magnetic particles 218 which may assist with dispersing the first plurality of magnetic particles 218 and lysing the cell 213. The first plurality of magnetic particles 218 may be released from the magnetic field in a variety of ways. In some examples, the first resistor 214 may heat the first plurality of magnetic particles 218 above a Curie temperature of the first plurality of magnetic particles 218 and, in response, release the first plurality of magnetic particles 218 from the magnetic field via the heat to disperse the first plurality of magnetic particles 218 from the magnetic field, and create a vapor bubble within the microfluidic channel 212 to move the first plurality of magnetic particles 218 through the microfluidic channel 212. For example, the first resistor 214 may move the first plurality of magnetic particles 218 via the vapor bubble, such as in the direction of the arrow 215 and via activation by coupled circuitry. In such examples, a permanent magnet may be used, but examples are not so limited.

In other examples, the first magnet 216 may include an electromagnet that selectively provides the magnetic field. The magnetic field may be disabled prior to activating the first resistor 214 to generate the movement and then enabled between firings to coral the first plurality of magnetic particles 218 for subsequent lysing and/or to mitigate loss of the first plurality of magnetic particles 218. For example, the apparatus 210 may include circuitry that applies energy to the first magnet 216 to provide the magnetic field. The circuitry may remove the energy to remove the magnetic field and release the first plurality of magnetic particles 218. As described above, the circuitry may further activate the first resistor 214 to create the vapor bubble to move the first plurality of magnetic particles 218 through the microfluidic channel 212.

FIG. 2C illustrates an example release of cellular material 223-1, 223-2 after lysing the cell. As shown by FIG. 2C, the apparatus 210 may further include a second resistor 217 and an orifice 219 located near the second resistor 217. The orifice 219 may include a nozzle for ejecting fluid from the microfluidic channel 212, such as ejecting fluid from a microfluidic device. In some examples, the orifice 219 may include an interface to another microfluidic channel or a chamber of the microfluidic device for further processing and/or analysis. The second resistor 217 may be activated to eject the cellular material 223-1, 223-2 from the microfluidic channel 212, such as in the direction of the arrow 221 and via activation by the coupled circuitry. For example, the second resistor 217 may act as a pump to pull fluid including the cellular material 223-1, 223-2 through the microfluidic channel 212 and eject fluid from the orifice 219. The cellular material 223-1, 223-2 may be ejected onto a new fluid path and/or out of the microfluidic device onto a substrate. In some examples, the orifice 219 may be defined by a surface of the microfluidic channel 212, through which cellular fluid may be ejected in drops for further processing.

In the example of FIG. 2C, the cellular material 223-1, 223-2 may not bind to the first plurality of magnetic particles 218. However, in some examples, as shown by FIG. 2D, the first plurality of magnetic particles 218 may bind to a type of analyte among cellular material 223-1, 223-2 from a cell in the biologic sample. For example, the first plurality of magnetic particles 218 may include a coating that absorbs or otherwise binds to the type of analyte. By binding to the first plurality of magnetic particles 218, the analyte may be concentrated and may be protected from degradation. For example, some nucleic acids may be less prone to degradation when captured on a surface.

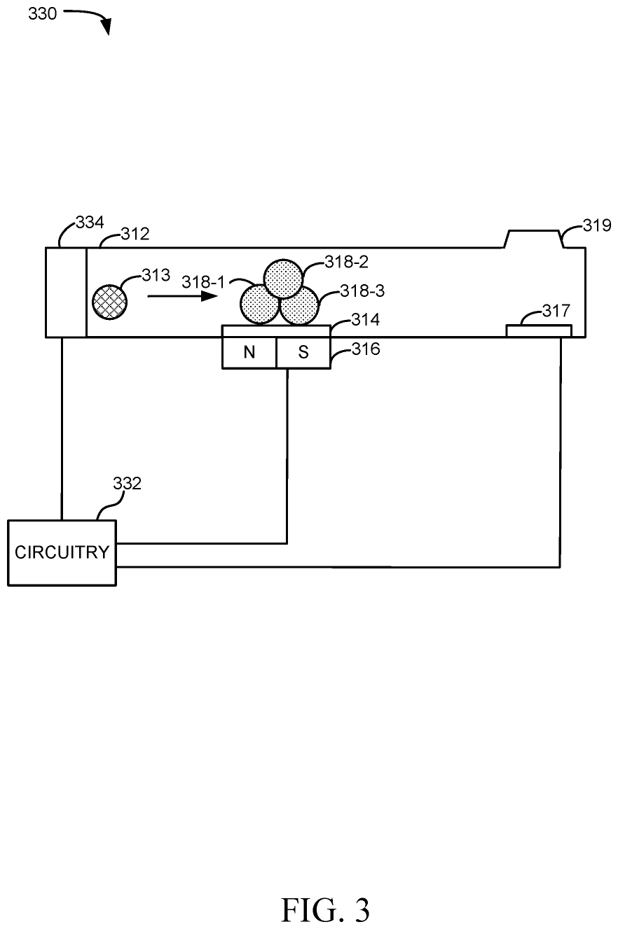

FIG. 3 illustrates another example apparatus including a microfluidic channel with a first magnet and a first resistor, in accordance with the present disclosure. Similar to FIG. 2A, the apparatus 330 includes a microfluidic channel 312 including a first plurality of magnetic particles 318-1, 318-2, 318-3, herein generally referred to as “the first plurality of magnetic particles 318” for ease of reference. The microfluidic channel 312 may pass a volume of a biologic sample. A first magnet 316 is disposed with the microfluidic channel 312 to provide a magnetic field that attracts the first plurality of magnetic particles 318. A first resistor 314 is disposed within the microfluidic channel 312.

In the particular example illustrated by FIG. 3, the first magnet 316 and the first resistor 314 are collocated. However, examples are not so limited, and the first magnet 316 and the first resistor 314 may be uncollocated, as further illustrated by FIG. 4A.

Circuitry 332 is coupled to the first resistor 314 to activate the first resistor 314. Activating the first resistor 314 may cause the dispersion of the first plurality of magnetic particles 318 from the magnetic field and movement of the first plurality of magnetic particles 318 through the microfluidic channel 312. The movement of the first plurality of magnetic particles 318 may result in lysing of a cell 313 in the biologic sample and release of cellular material from the cell 313, as previously described.

In some examples, the circuitry 332 may be used to control other components of the apparatus 330. For example, the apparatus 330 may include a microfluidic device and the circuitry 332 controls components of the microfluidic device. The microfluidic device may include the microfluidic channel 312, the first magnet 316 and the first resistor 314. Various fluidic pumps may be used to actively move fluid through the microfluidic channel 312 (and other microfluidic channels) of the microfluidic device, such as illustrated by the fluidic pump 334. The fluidic pumps may form part of the microfluidic device and/or may be separated from the microfluidic device, and controlled by the circuitry 332. The fluidic pump 334 may include an inertial pump that actuates the fluid. Example fluidic pumps include an integrated inertial pump, a TIJ resistor, a piezoelectric device, a magnetostrictive element, an ultrasound source, and other suitable pumps. For example, the fluidic pump 334 may be a thermal resistor that drives fluid flow along the microfluidic channel 312 in the direction of the arrow 311, as previously described.

Fluid flowing through the microfluidic channel 312 may be induced by operation of a single fluidic pump or multiple fluidic pumps located within the microfluidic channel 312. In some examples, the fluid may be induced by an external fluidic pump. In some example, the microfluidic channel 312 may include an array of fluidic pumps, such as an array resistors located inside and along the length of the microfluidic channel 312, which may be individually and/or collectively activated to pump fluid, to lyse a cell 313, and/or to eject fluid from the microfluidic channel 312. For example, the fluidic pump 334 may include a resistor that is disposed within a threshold distance of a cell fluid reservoir and/or an inlet of the microfluidic device from which the biologic sample is input. The fluidic pump 334 may act as a push pump by pushing fluid from left to right. Other resistors outside the threshold may act to lyse the cell 313 and/or eject fluid from the microfluidic channel 312, such as the illustrated resistors 314, 317.

While fluidic pumps may move the biologic sample through the microfluidic channel 312 in the form a fluid flow, examples are not so limited. For example, the fluidic pumps may move the biologic sample by agitating the fluid within the microfluidic channel 312 and without creating a fluid flow. The fluidic pumps may be individually actuated to induce a different respective flow of fluid within the microfluidic channel 312.

In some examples, the circuitry 332 is coupled to the first magnet 316 and used to control the magnetic field provided by the first magnet 316. For example, the first magnet 316 may include an electromagnet. The circuitry 332 may apply energy to the first magnet 316 to provide the magnetic field within the microfluidic channel 312. The circuitry 332 may remove the energy to remove the magnetic field and release the first plurality of magnetic particles 318 from the magnetic field prior to or concurrently with activating the first resistor 314. However, examples are not so limited, and in some examples, the first magnet 316 is a permanent magnet and the first resistor 314 or another heat source may heat the first plurality of magnetic particles 318 to release the particles from the magnetic field and/or the first plurality of magnetic particles 318 may be released by the vapor bubble created by the first resistor 314.

In various examples, the apparatus 330 may include a second resistor 317 and orifice 319 for ejecting the cellular material from the microfluidic channel 312. In some examples, the apparatus 330 may further include the second resistor 317 disposed within the microfluidic channel 312 and a sensor to detect a sensor signal that indicates whether the cell 313 is lysed, such as further illustrated by FIG. 4D. In response to the sensor signal being indicative of the cell 313 being lysed, the circuitry 332 may activate the second resistor 317 to eject the cellular material from the microfluidic channel 312. For example, the activation of the second resistor 317 may cause the cellular material to eject from the microfluidic channel 312.

In some examples, the apparatus 330 may include additional magnetic particles. For example, the microfluidic channel 312 may include a second plurality of magnetic particles. The first plurality of magnetic particles 318 and second plurality of magnetic particles may include different types of particles, such as different densities, sizes, coatings, and/or Curie temperatures, which may be used to sort different types of analytes. In some examples, the analytes may be sorted using filters, sensors, additional magnets, among other techniques as further illustrated herein.

FIGS. 4A-4D illustrate a variety of different example apparatuses for performing cell lysis with a first plurality of magnetic particles and a first resistor, in accordance with the present disclosure. The apparatuses 440, 441, 443, 445 may include substantially the same features as previously described by FIG. 3. For example, each of the apparatuses 440, 441, 443, 445 include a microfluidic channel 412, a first plurality of magnetic particles 418-1, 418-2, 418-3 (herein generally referred to as “the first plurality of magnetic particles 418” for ease of reference), a first magnet 416, and a first resistor 414.

As shown by FIG. 4A, an example apparatus 440 includes a first resistor 414 that is uncollocated with the first magnet 416 within the microfluidic channel 412. For example, the first magnet 416 may be upstream from the first resistor 414 within the microfluidic channel 412. The first magnet 416 may be a moving magnet and/or an electromagnet that is controlled by the coupled circuitry, such as circuitry 332 illustrated by FIG. 3. The magnetic field may be removed and the first resistor 414 may create the vapor bubble to disperse the first plurality of magnetic particles 418, as previously described.

In some examples, a second resistor 415 or other heat source may be collocated with the first magnet 416 to heat the first plurality of magnetic particles 418 above the Curie temperature and, in response, to release the first plurality of magnetic particles 418 from the magnetic field. As described above, the first resistor 414 may create a vapor bubble within the microfluidic channel 412 to disperse the first plurality of magnetic particles 418 from the magnetic field and move the first plurality of magnetic particles 418 through the microfluidic channel 412.

As shown by FIG. 4B, an example apparatus 441 may be used to provide a converging lysing process. The microfluidic channel 412 may further include a second plurality of magnetic particles 442-1, 442-2, 442-3. A second magnet 446 may be disposed with the microfluidic channel 412 to provide a second magnetic field that attracts the second plurality of magnetic particles 442-1, 442-2, 442-3. A second resistor 444 may be disposed within the microfluidic channel 412. Similar to the first resistor 414, the second resistor 444 may disperse the second plurality of magnetic particles 442-1, 442-2, 442-3 from the second magnetic field and move the second plurality of magnetic particles 442-1, 442-2, 442-3 through the microfluidic channel 412. The first plurality and second plurality of magnetic particles 418, 442-1, 442-2, 442-3 may lyse the cell 413. For example, the first and second plurality of magnetic particles 418, 442-1, 442-2, 442-3 may move from both sides of and converge proximal to the cell 413. The first magnet 416 and first resistor 414 may be upstream from the second magnet 446 and second resistor 444. As with other example apparatuses, the apparatus 441 may include a third resistor 417 used to eject the extracellular material from the microfluidic channel 412. The first and second plurality of magnetic particles 418, 442-1, 442-2, 442-3 may include the same type or different type of magnetic particles.

In some examples, the microfluidic channel 412 may include different types of magnetic particles. For example, FIG. 4C illustrates an example apparatus 443 that includes the first plurality of magnetic particles 418 that each include a first type of magnetic particle and a second plurality of magnetic particles 456-1, 456-2, 456-3 that each include a second type of magnetic particle. The first type of magnetic particle may include a first coating that binds to a first type of cellular material. The second type of magnetic particle may includes a second coating that binds to a second type of cellular material.

The different types of magnetic particles may be used for sorting the cellular material. For example, the first plurality of magnetic particles 418 and second plurality of magnetic particles 456-1, 456-2, 456-3 may have different densities. The first magnet 416 may attract the first plurality and second plurality of magnetic particles 418, 456-1, 456-2, 456-3, and the first resistor 414 disperses and moves the first plurality and second plurality of magnetic particles 418, 456-1, 456-2, 456-3 through the microfluidic channel 412 to lyse the cell 413. Due to the different densities, the first plurality and second plurality of magnetic particles 418, 456-1, 456-2, 456-3 may travel different distances along the microfluidic channel 412, such as different upstream distances from the first resistor 414.

The apparatus 443 may further include additional magnets and resistors. For example, the apparatus 443 includes a second magnet 450 disposed with the microfluidic channel 412 to provide a second magnetic field that attracts the first plurality of magnetic particles 418 after the movement by the first resistor 414. A second resistor 448 is disposed within the microfluidic channel 412 to selectively disperse the first plurality of magnetic particles 418 from the second magnet 450 and to move the first plurality of magnetic particles 418 through the microfluidic channel 412 toward the first magnet 416. The apparatus 443 further includes a third magnet 454 disposed with the microfluidic channel 412 to provide a third magnetic field that attracts the second plurality of magnetic particles 456-1, 456-2, 456-3 after the movement by the first resistor 414. A third resistor 452 is disposed within the microfluidic channel 412 to selective disperse the second plurality of magnetic particles 456-1, 456-2, 456-3 from the third magnet 454 and to move the second plurality of magnetic particles 456-1, 456-2, 456-3 through the microfluidic channel 412 toward the first magnet 416. The (fourth) resistor 417 may act as an ejection pump, to selectively eject or sort the first and second pluralities of magnetic particles 418, 456-1, 456-2, 456-3.

However examples are not so limited, and the different types of cellular material may be sorted by using filters, as further illustrated herein, and/or magnetic particles that have different Curie temperatures. For example, the first resistor 414 and first magnet 416 may recollect the first and second plurality of magnetic particles 418, 456-1, 456-2, 456-3, and selectively disperse the first plurality of magnetic particles 418 by heating to a first Curie temperature associated with the first plurality of magnetic particles 418 to release the first plurality of magnetic particles 418 from the magnetic field. The first resistor 414 may subsequently heat to a second Curie temperature associated with the second plurality of magnetic particles 456-1, 456-2, 456-3 to release the second plurality of magnetic particles 456-1, 456-2, 456-3 from the magnetic field. The second Curie temperature may be higher than the first Curie temperature. Depending on the particular analysis, the first plurality of magnetic particles 418 and second plurality of magnetic particles 456-1, 456-2, 456-3 may be selectively provided downstream for further analysis, ejected to a substrate for analysis, and/or provided to a waste reservoir.

As previously described, various examples further include a sensor used to detect whether the cell 413 is lysed. As shown by FIG. 4D, an example apparatus 445 includes a sensor 458 to detect a sensor signal that indicates whether the cell is lysed. The apparatus 445 includes the second resistor 417, which may be a third or fourth resistor in different examples, disposed within the microfluidic channel 412 and acting as an ejection pump in some examples. In response to the sensor signal indicating the cell is lysed, as shown by the cellular material 423-1, 423-2, the circuitry 432 may active the second resistor 417 to eject the cellular material 423-1, 423-2 from the microfluidic channel 412.

Although not illustrated, in some examples, the sensor signal may be indicative of the cell having a cellular membrane. In response, the circuitry 432 may allow the cell to continue along the microfluidic channel 412. For example, the cell may continue along the microfluidic channel 412 and be exposed to an additional lysis process, such as further illustrated herein.

The sensor 458 may be a variety of different types of sensors used to provide the monitoring and/or feedback to the circuitry 432. Example sensors include an impedance sensor, an image sensor, a light sensor, among other types of sensors. For an impedance sensor, the buffer solution may be non-conductive, such as a phosphate buffer. As cells are conductive, an impedance detected by the impedance sensor may indicate a cell has a cellular membrane and is unlysed. For the light sensor, light scattering with the microfluidic channel 412, such as downstream from the first resistor 414, may be monitored. The light sensor may be used with bacteria and small cells, which may be difficult to sense using an image sensor.

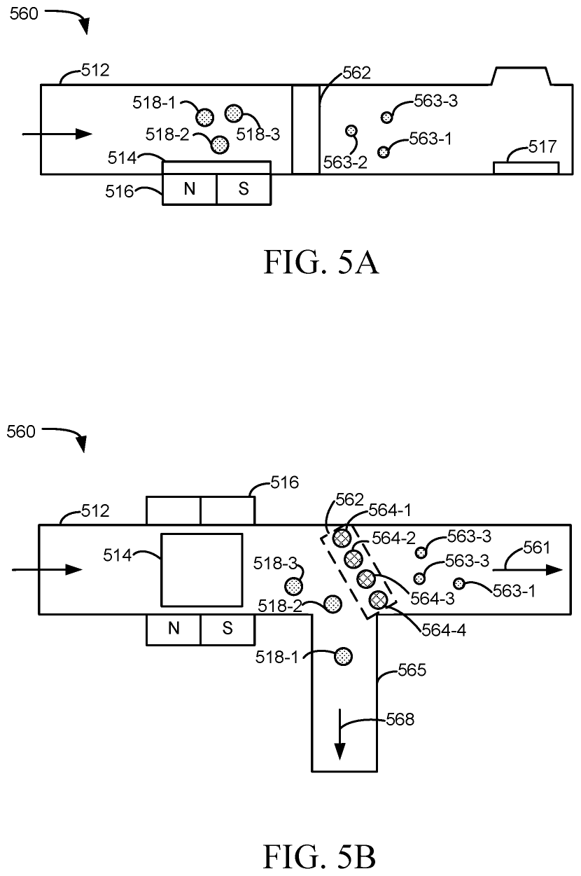

FIGS. 5A-5B illustrate views of an example apparatus for performing cell lysis and sorting with a first plurality of magnetic particles and a first resistor, in accordance with the present disclosure. In some examples, a particular analyte may be sorted using the apparatus 560 which includes a filter 562 disposed within the microfluidic channel 512 to filter the first plurality of magnetic particles 518-1, 518-2, 518-3 (herein generally referred to as “the first plurality of magnetic particles 518” for ease of reference) from the biologic sample and permit the cellular material to pass through the filter 562.

FIG. 5A illustrates a side view of the example apparatus 560 that includes the first resistor 514, the first magnet 516, the first plurality of magnetic particles 518, and the filter 562. In some examples, the filter 562 may block the first plurality of magnetic particles 518 from passing and allow cellular material to pass. The dimension of the filter 562 may be selected to capture the first plurality of magnetic particles 518 and to target cellular material, such as allowing cellular material to pass.

In some examples, the apparatus 560 includes a second resistor 517 and orifice as previously described. The second resistor 517 may be used to push and pull fluid within the microfluidic channel 512. For example, the second resistor 517 may pull the cellular material through the filter 562 and/or subsequently push the first plurality of magnetic particles 518 away from the filter 562. Depending on the location of the first resistor 514 in the microfluidic channel 512 relative to other components, the first resistor 514 may serve an additional function other than lysing cells. For example, the first resistor 514 may act as a pump, moving fluid within the microfluidic channel 512 and/or a cleaner of the filter 562 that removes material from the filter 562.

In some examples, the apparatus 560 further includes a second plurality of magnetic particles 563-1, 563-2, 563-3, herein generally referred to as “the second plurality of magnetic particles 563” for ease of reference. As previously described, the first plurality of magnetic particles 518 may include a first size and/or a first coating that binds to a first type of cellular material. The second plurality of magnetic particles 563 may include a second size and/or a second coating that binds to a second type of cellular material.

FIG. 5B illustrates a top view of the example apparatus 560 as illustrated by FIG. 5A. As shown, the filter 562 may include a plurality of pillars 564-1, 564-2, 564-3, 564-4 that are spaced to permit the second plurality of magnetic particles 563 to pass through the filter 562 and to filter the first plurality of magnetic particles 518. The pillars 564-1, 564-2, 564-3, 564-4 may be a variety of different shapes, such as elongated pillars and/or different geometric shaped pillars. In other examples, the filter 562 may include a solid structure with apertures formed therein, with the apertures providing fluidic communication between the sides of the filter 562. The filter 562 may be formed of a variety of materials, such as SU8 material, epoxy-based negative photoresist material, and/or other suitable material.

The first plurality and second plurality of magnetic particles 518, 563 may be dispersed by the first resistor 514 to lyse a cell. The different types of magnetic particles 518, 563 bind to the different types of cellular material. In some examples, larger sized particles may be stopped by the filter 562 and smaller sized particles may travel downstream along the microfluidic channel 512. In some examples, the first plurality of magnetic particles 518 may travel along a branching channel 565 in a first direction 568, such as to a waste reservoir. For example, the first plurality of magnetic particles 518 may be ejected from the branching channel 565 via an additional orifice and/or additional resistor. The second plurality of magnetic particles 563 may travel along the microfluidic channel 512 in a second direction 561 and may be ejected to an analysis chamber or to a substrate, as previously described. The filter 562 may allow for separating different cellular material for sorting based on the size of the respective magnetic particles.

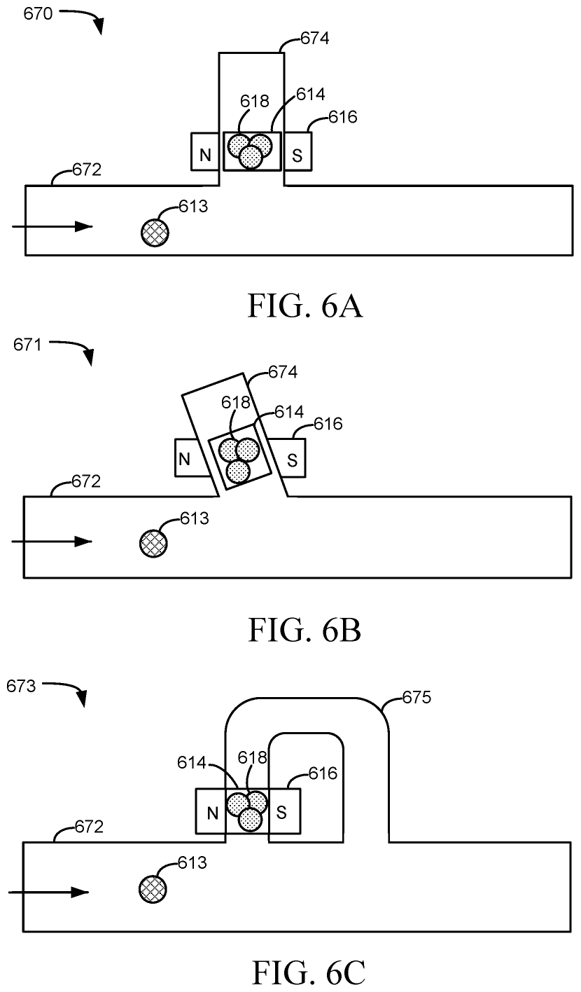

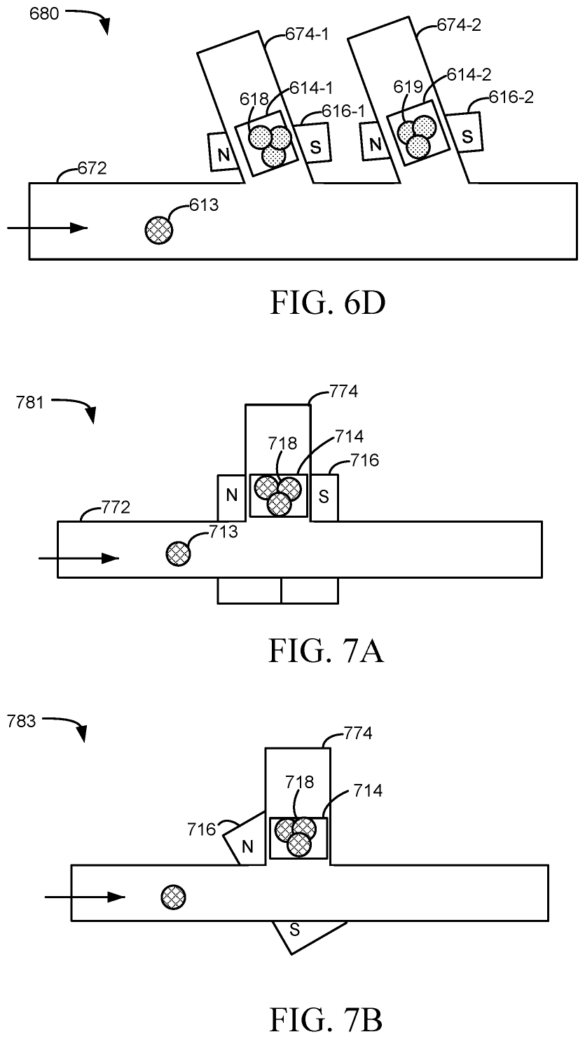

FIGS. 6A-6D illustrate a variety of different example apparatuses for performing cell lysis with a first plurality of magnetic particles and a first resistor, in accordance with the present disclosure. In various examples, as shown by example apparatuses 670, 671, 673, the microfluidic channel of an apparatus may include a first channel 672 and a second channel 674, 675. The first channel 672 may pass the volume of the biologic sample including the cell 613. The second channel 674, 675 may intersect the first channel 612. The first magnet 616 may be disposed with the second channel 674, 675 and the first resistor 614 may be disposed within the second channel 674, 675. The first magnet 616 may corral the first plurality of magnetic particles 618 within the second channel 674, 675.

The second channel 674, 675 may include a branching channel or a recirculation loop. FIG. 6A illustrates an example apparatus 670 which includes a second channel 674 that is a branching channel which forms a T-junction with the first channel 672. FIG. 6B illustrates an example apparatus 671 which includes a second channel 674 that is a branching channel which forms a side junction with the first channel 672. FIG. 6C illustrates an example apparatus 673 which includes a second channel 675 that is a recirculation loop including a first end and a second end coupled to the first channel 672. The cell 613 may recirculate along the recirculation loop and a lysis process may be performed at each recirculation. For example, the first plurality of magnetic particles 618 and the cell 613 may be pulled into the recirculation loop by an additional resistor located at the second end of the recirculation loop to be subjected to another lysing process.

Although FIGS. 6A-6C illustrate a branching channel or recirculation loop, examples are not so limited. For example, a plurality of branching channels and/or recirculation loops may intersect the first channel 672. In such examples, the apparatuses may perform multiple lysing processes. For example, each of the plurality of branching channels and/or recirculation loops may include a respective resistor, a magnet, and a plurality of magnetic particles.

For example, FIG. 6D illustrates an example apparatus 680 that includes multiple branching channels 674-1, 674-2. The apparatus 680 includes a first channel 672 coupled to the first branching channel 674-1 and to the second branching channel 674-2. The first channel 672 may pass the volume of the biologic sample including the cell 613. A first magnet 616-1 may be disposed with the first branching channel 674-1 and the first resistor 614-1 may be disposed within the first branching channel 674-1. A second magnet 616-2 may be disposed with the second branching channel 674-2 and a second resistor 614-2 may be disposed within the second branching channel 674-2. As the cell 613 passes along the first channel 672, the cell 613 may be exposed to a first lysing action by the first plurality of magnetic particles 618, which are attracted to the first magnet 616-1, via activation of the first resistor 614-1. In some examples, the cell 613 may be exposed to a second lysing process by the second plurality of magnetic particles 619, which are attracted to the second magnet 616-2, via activation of the second resistor 614-2.

Although FIG. 6D illustrates branching channels 674-1, 674-2 that form side junctions with the first channel 672, examples are not so limited and example apparatuses may include multiple branching channels that form T-junctions and/or recirculation loops. In some examples, a sensor(s) may be located downstream of the second channels to detect whether lysing has occurred, as previously described. In response, the cell 613 may be ejected from the first channel 612 without further lysing processes or may travel further downstream the first channel 612 for the additional lysing process(es).

FIGS. 7A-7B illustrate a variety of different example apparatuses for performing cell lysis with a first plurality of magnetic particles and a first resistor, in accordance with the present disclosure. Examples are not limited to positioning of the magnets as that previously illustrated. FIGS. 7A-7B illustrate example variations of placements of the first magnet 716 for corralling the first plurality of magnetic particles 718. The example apparatuses 781, 783 include a microfluidic channel that is formed of a first channel 772 and a second channel 774. A first magnet 716 is disposed with the second channel 774 and a first resistor 714 is disposed within the second channel 774 to perform lysing on a cell 713 flowing along the first channel 772.

As shown by FIG. 7A, an example apparatus 781 may include a first magnet 716 that is of a size to be disposed with respect to both the first channel 772 and the second channel 774. As shown by FIG. 7B, another example apparatus 783 may include a first magnet 716 that is at an angle with respect to the first channel 772 and/or the second channel 774. Although FIGS. 7A-7B illustrate a branching channel that forms a T-junction with the first channel 772, examples are not so limited and apparatuses may include multiple branching channels that form side junctions and/or multiple recirculation loop.

Example apparatuses in accordance with the present disclosure include microfluidic devices and coupled circuitry used to provide mechanical lysing using particle-to-particle cell collisions and/or shear force generated by moving particles. Higher shear rates and larger area of shear may be generated, as compared to use of a steam bubble, leading to faster and more complete, and/or more uniform cell lysis. Various examples increase the maximum shear stress that may be imposed on cells inside a microfluidic device and allows for providing mechanical lysis within the microfluidic device. Examples are applicable to single cell disruption and/or multi-cell disruption.

The various figures herein illustrate three magnetic particles of a particular type and two different types of magnetic particles. However, examples are not limited, and the number of the first plurality of magnetic particles and the number of the second plurality of magnetic particles may include more or less than three. Further, in various examples, greater than two different types of magnetic particles may be used. Although the various apparatus illustrate symmetrical designs, examples are not so limited. For example, the microfluidic devices may include high through-put and/or parallel designs.

Circuitry as used herein, such as circuitry 332, 432, may include a processor, machine readable instructions, and other electronics for communicating with and controlling the fluidic pumps, and other components of the apparatus, such as the sensor, the magnet(s), the resistor(s), and other components. The circuitry may receive data from a host system, such as a computer, and includes memory for temporarily storing data. The data may be sent to the apparatus along an electronic, infrared, optical, or other information transfer path. A processor may be a central processing unit (CPU), a semiconductor-based microprocessor, a graphics processing unit (GPU), a microcontroller, special purpose logic hardware controlled by microcode or other hardware devices suitable for retrieval and/or execution of instructions stored in a memory, or combinations thereof. In addition to or alternatively to retrieving and executing instructions, the processor may include at least one integrated circuit (IC), other control logic, other electronic circuits, or combinations thereof that include a number of electronic components for performing the function. In some examples, the circuitry includes non-transitory computer-readable storage medium that is encoded with a series of executable instructions that may be executed by the processor. Non-transitory computer-readable storage medium may be an electronic, magnetic, optical, or other physical storage device that contains or stores executable instructions. Thus, non-transitory computer-readable storage medium may be, for example, Random Access Memory (RAM), an Electrically Erasable Programmable Read-Only Memory (EEPROM), a storage device, an optical disc, etc. In some examples, the computer-readable storage medium may be a non-transitory storage medium, where the term ‘non-transitory’ does not encompass transitory propagating signals.

A biologic sample, as used herein, refers to any biological material, collected from a subject. Examples of biologic samples include, but are not limited to, whole blood, blood plasma, and other body fluids, as well as tissue cell cultures obtained from humans, plants, or animals. Such biologic samples may contain any viral or cellular material, including all prokaryotic or eukaryotic cells, viruses, bacteriophages, mycoplasmas, protoplasts, and organelles. The biological material may comprise all types of mammalian and non-mammalian animal cells, plant cells, algae including blue-green algae, fungi, bacteria, protozoa, etc. Non-limiting sample examples include whole blood and blood-derived products such as plasma, serum and buffy coat, urine, feces, cerebrospinal fluid or other body fluids, tissues, cell cultures, cell suspensions, etc. The term “fluid”, as used herein, refers to any substance that flows under applied shear stress. In some examples, the fluid includes the biologic sample including an analyte and/or a reagent or reactant, among others.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A method comprising:
receiving, at a microfluidic channel, a biologic sample including a cell;
providing a magnetic field within the microfluidic channel using a first magnet, wherein the magnetic field attracts a first plurality of magnetic particles disposed within the microfluidic channel;
activating a first resistor disposed within the microfluidic channel to agitate a volume of fluid within the microfluidic channel; and
in response to agitating the volume of fluid, moving the first plurality of magnetic particles through the microfluidic channel to lyse the cell and to release cellular material from the cell.

2. The method of claim 1, wherein moving the first plurality of magnetic particles includes moving the first plurality of magnetic particles at a different velocity than a velocity of surrounding fluid, thereby generating local shear near the cell.

3. The method of claim 1, further including heating the first plurality of magnetic particles prior to agitating the volume of fluid to control magnetic properties of the first plurality of magnetic particles.

4. The method of claim 1, further including:
applying energy to the first magnet to provide the magnetic field; and
removing the energy to remove the magnetic field and release the first plurality of magnetic particles prior to activating the first resistor.

5. The method of claim 1,
providing a second magnetic field within the microfluidic channel using a second magnet, wherein the second magnetic field attracts a second plurality of magnetic particles disposed within the microfluidic channel; and
activating a second resistor disposed within the microfluidic channel to agitate a second volume of fluid within the microfluidic channel, and in response, moving the second plurality of magnetic particles through the microfluidic channel, wherein the first plurality and second plurality of magnetic particles are to lyse the cell, and the first magnet and the first resistor are downstream from the second magnet and the second resistor within the microfluidic channel.

6. An apparatus comprising:
a microfluidic channel including a first plurality of magnetic particles, the microfluidic channel to pass a volume of a biologic sample;
a first magnet disposed with the microfluidic channel to provide a magnetic field that attracts the first plurality of magnetic particles; and
a first resistor disposed within the microfluidic channel and collocated with the first magnet.

7. The apparatus of claim 6, further including circuitry coupled to the first resistor to disperse the first plurality of magnetic particles from the magnetic field and move the first plurality of magnetic particles through the microfluidic channel to lyse a cell in the biologic sample and to release cellular material from the cell.

8. The apparatus of claim 6, wherein the first resistor is further to:
heat the first plurality of magnetic particles above a Curie temperature of the first plurality of magnetic particles and, in response, to:
release the first plurality of magnetic particles from the magnetic field via the heat to disperse the first plurality of magnetic particles from the magnetic field; and
create a vapor bubble within the microfluidic channel to move the first plurality of magnetic particles through the microfluidic channel.

9. The apparatus of claim 6, wherein:
the first magnet is an electromagnet; and
the apparatus further includes circuitry to:
apply energy to the first magnet to provide the magnetic field; and
remove the energy to remove the magnetic field and release the first plurality of magnetic particles.

10. The apparatus of claim 6, wherein the first plurality of magnetic particles are to bind to a type of analyte among cellular material from a cell in the biologic sample.

11. An apparatus comprising:
a microfluidic channel including a first plurality of magnetic particles, the microfluidic channel to pass a volume of a biologic sample;
a first magnet disposed with the microfluidic channel to provide a magnetic field that attracts the first plurality of magnetic particles;
a first resistor disposed within the microfluidic channel; and
circuitry coupled to the first resistor to activate the first resistor to disperse the first plurality of magnetic particles from the magnetic field and move the first plurality of magnetic particles through the microfluidic channel to lyse a cell in the biologic sample and to release cellular material from the cell.

12. The apparatus of claim 11, wherein the circuitry is to:
apply energy to the first magnet to provide the magnetic field; and
remove the energy to remove the magnetic field and release the first plurality of magnetic particles from the magnetic field prior to activating the first resistor.

13. The apparatus of claim 11, further including:
a sensor to detect a sensor signal that indicates whether the cell is lysed;
a second resistor disposed within the microfluidic channel; and
wherein in response to the sensor signal being indicative of the cell being lysed, the circuitry is to activate the second resistor to eject the cellular material from the microfluidic channel.

14. The apparatus of claim 13, wherein in response to the sensor signal being indicative of the cell having a cellular membrane, the circuitry is allow the cell to continue along the microfluidic channel.

15. The apparatus of claim 11, further including:
a filter disposed within the microfluidic channel to filter the first plurality of magnetic particles from the biologic sample and permit the cellular material to pass through the filter; and
a second plurality of magnetic particles, wherein the first plurality of magnetic particles including a first size and a first coating, and the second plurality of magnetic particles including a second size and a second coating, the first coating to bind to a first type of cellular material and the second coating to bind to a second type of cellular material, wherein the filter is to filter the first plurality of magnetic particles and permit the second plurality of magnetic particles to pass through the filter.
